(19) United States
(12) Patent Application Publication
(10) Pub. No.: US 2025/0302701 A1
(43) Pub. Date: Oct. 2, 2025

(54) FEEDING BOTTLE WITH AIR RETURN FUNCTION

(71) Applicant: Guangzhou Aiduoqi Infant and Child Products Co., Ltd., Guangzhou (CN)

(72) Inventor: Guorong XIE, Shijiazhuang (CN)

(73) Assignee: Guangzhou Aiduoqi Infant and Child Products Co., Ltd., Guangzhou (CN)

(21) Appl. No.: 18/635,665

(22) Filed: Apr. 15, 2024

(30) Foreign Application Priority Data
Mar. 29, 2024 (CN) 2024206391277

(51) Int. Cl. A61J 9/04; A61J 9/00

(52) U.S. Cl. CPC A61J 9/04; A61J 9/006

(57) ABSTRACT

A feeding bottle with an air return function is provided. A bottle body is provided with an open end and an air guide mechanism, and an outer wall of the open end is provided with threads; and a bottle cap is on the open end and configured to fasten the bottle body and a nipple, an annular air groove is provided in the middle of one side of an air guide plate, an isolation tube is firmly disposed in the middle of the annular air groove, a liquid guide channel is provided in the middle of the isolation tube, an air guide tube is firmly disposed on one side, away from the annular air groove, of the air guide plate, and the inside of the air guide tube communicates with the annular air groove, effectively preventing bloating during sucking, and helping to improve use quality of the feeding bottle.

### CROSS-REFERENCE TO RELATED APPLICATIONS

The application claims priority to Chinese patent application No. 2024206391277, filed on Mar. 29, 2024, the entire contents of which are incorporated herein by reference.

### TECHNICAL FIELD

The present invention relates to the technical field of infant products, and in particular to improvement of a feeding bottle.

### BACKGROUND

During the use of traditional infant feeding bottles, infants usually tend to inhale a specific amount of air while sucking, leading to flatulence, abdominal discomfort even crying, and the like. Although some anti-flatulent feeding bottles are designed on the market, such anti-flatulent feeding bottles are usually complicated in structure and difficult to clean, or have limited anti-bloating effect.

### SUMMARY

### (1) Technical Problems to be Resolved

In view of shortcomings of the existing technology, the present invention provides a feeding bottle with an air return function. The feeding bottle prevents air from passing through the milk, and the milk does not produce bubbles, which effectively prevents bloating while an infant is sucking milk, and prevents loss of vitamins caused by contact between milk and air, helping to improve the use quality of the feeding bottle and providing advantages of a simple structure and easy cleaning, so that the problem of infant spitting up, choking, or bloating caused by inhaling air that is raised in the above-mentioned background technology are resolved.

### (2) Technical Solutions

To achieve the above-mentioned advantages of reducing a resistance to milk flowing and allowing the infant to suck the milk without effort, specific technical solutions used in the present invention are as follows:
a feeding bottle with an air return function, including a bottle body, a nipple, and a bottle cap, where the bottle body is provided with an open end and an air guide mechanism, and an outer wall of the open end is provided with threads; and the bottle cap is located on the open end and is configured to fasten the bottle body and the nipple, the air guide mechanism includes an air guide plate, an isolation tube, and an air guide tube, an annular air groove is provided in the middle of one side of the air guide plate, the isolation tube is firmly disposed in the middle of the annular air groove, a liquid guide channel is provided in the middle of the isolation tube for communication between two sides of the air guide plate, the air guide tube is firmly disposed on one side that is of the air guide plate and that is away from the annular air groove, and the inside of the air guide tube communicates with the annular air groove for air delivery, the nipple is provided with an air inlet hole, and air enters the annular air groove through the air inlet hole.

Further, the bottle body is a transparent bottle body and may be made of any one of glass, a PPSU material, silicone, or plastic.

Further, a milk hole is provided at a protrusion in the middle of a mouth of the nipple, the nipple is a dual-hardness silicone nipple, an upper part is made of a slightly thinner silicone material, and a lower part is made of a slightly thicker silicone material.

Further, a hard gasket is fastened to a side of a side wall of the air guide plate, and the hard gasket is located on one side that is of the air guide plate and that is away from the air guide tube.

Further, an air guide through hole is provided at a position at which a side wall of the air guide plate is corresponding to the annular air groove for communication between the air guide tube and the annular air groove.

### (3) Beneficial Effects

Compared with the conventional technologies, the present invention provides a feeding bottle with an air return function and has the following beneficial effects.

Loss of vitamins in milk can be reduced, the infant does not easily spit up milk due to inhalation of air, and a resistance to milk flowing is reduced, so that the infant can suck milk without effort. When the infant is not sucking milk in the feeding bottle, natural flowing of milk can be reduced as much as possible (that is, a positive pressure generated during bottle feeding is reduced to a minimum), and bubbles are not generated in the milk, reducing occurrence of spiting up milk, choking, or flatulence when the infant sucks milk. The feeding bottle has advantages of a simple production process, facilitating mass industrial production, a simple structure, and being easily cleaned.

### BRIEF DESCRIPTION OF DRAWINGS

To describe the technical solutions in the embodiments of the present invention or in the prior art more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic structural diagram of the present invention;

FIG. 2 is a schematic structural diagram of an air guide plate 41 of the present invention;

FIG. 3 is a schematic structural diagram of the present invention; and

FIG. 4 is a schematic structural diagram of a nipple 2 of the present invention.

In the drawings: bottle body 1, nipple 2, bottle cap 3, air guide mechanism 4, open end 11, air guide plate 41, isolation tube 42, air guide tube 43, annular air groove 411, hard gasket 412, liquid guide channel 421.

### DETAILED DESCRIPTION OF THE EMBODIMENTS

To further describe embodiments, the present invention provides drawings. The drawings are a part of the disclosure of the present invention, and are mainly used to illustrate the embodiments and can be used in conjunction with the relevant descriptions in the specification to explain operating principles of the embodiments. With reference to the content, a person skilled in the art shall understand other possible implementations and advantages of the present invention. Components in the drawings are not drawn to scale, and similar component symbols are usually used to represent similar components.

According to an embodiment of the present invention, a feeding bottle with an air return function is provided.

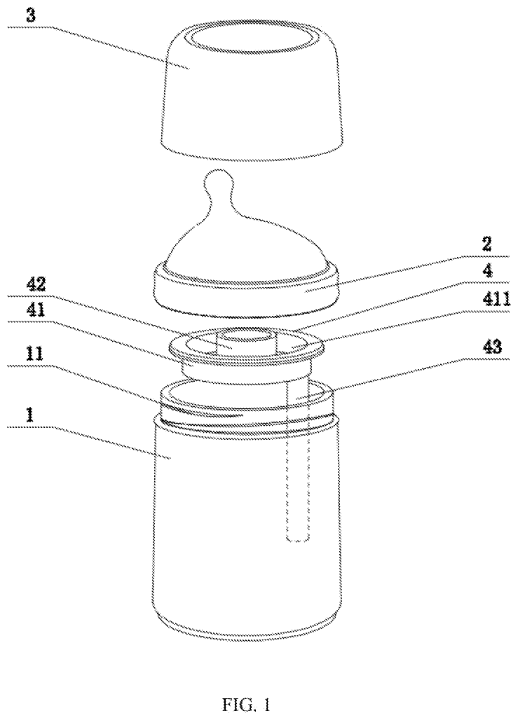

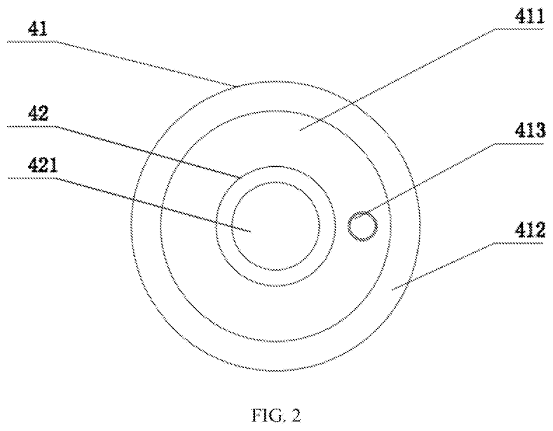

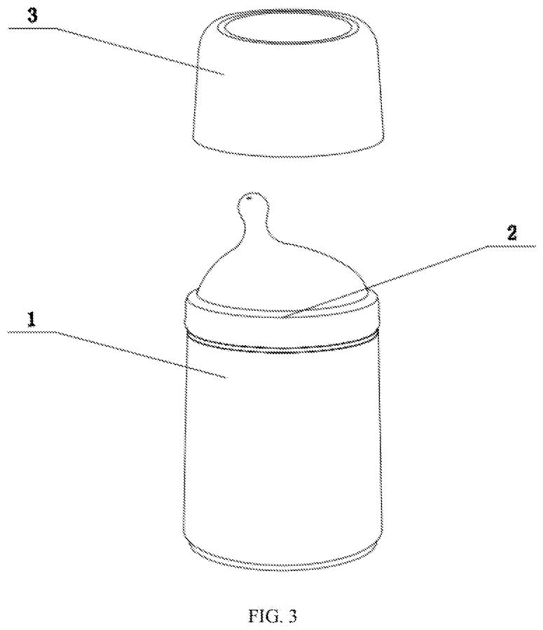

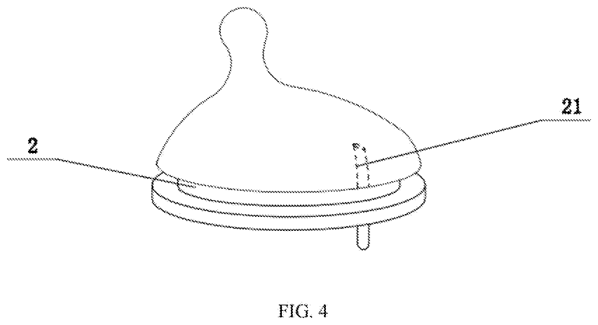

The present invention will now be further described with reference to the accompanying drawings and specific implementations. As shown in FIG. 1 to FIG. 4, a feeding bottle with an air return function according to an embodiment of the present invention includes a bottle body 1, a nipple 2, and a bottle cap 3. The bottle body 1 is provided with an open end 11 and an air guide mechanism 4, and an outer wall of the open end 11 is provided with threads. The bottle cap 3 is located on the open end 11 and is configured to fasten the bottle body 1 and the nipple 2. The air guide mechanism 4 includes an air guide plate 41, an isolation tube 42, and an air guide tube 43. An annular air groove 411 is provided in the middle of one side of the air guide plate 41 for separation of gas and liquid. The isolation tube 42 is firmly disposed in the middle of the annular air groove 411. A liquid guide channel 421 is provided in the middle of the isolation tube 42 for communication between two sides of the air guide plate 41. The air guide tube 43 is firmly disposed on one side that is of the air guide plate 41 and that is away from the annular air groove 411, and the inside of the air guide tube 43 communicates with the annular air groove 411 for air delivery. The nipple 2 is provided with an air inlet hole 21, and air enters the annular air groove 411 through the air inlet hole 21 and then enters the bottom of the bottle through the air guide tube 43. Inhaled milk can be effectively separated from air, reducing a chance that an infant swallows air. Loss of vitamins in milk can be reduced, the infant does not easily spit up milk due to inhalation of air, and a resistance to milk flowing is reduced, so that the infant can suck milk without effort. When the infant is not sucking milk in the feeding bottle, natural flowing of milk can be reduced as much as possible (that is, a positive pressure generated during bottle feeding is reduced to a minimum), and bubbles are not generated in the milk, reducing occurrence of spiting up milk, choking, or flatulence when the infant sucks milk.

In one embodiment, the bottle body 1 is a transparent bottle body and may be made of any one of glass, a PPSU material, silicone, or plastic. The feeding bottle is used according to actual demands.

In one embodiment, a milk hole is provided at a protrusion in the middle of a mouth of the nipple 2, and a shape of the milk hole includes but is not limited to the following shapes: a cross-shape, a Y-shape, a straight-shape, or the like. The nipple 2 is a dual-hardness silicone nipple, an upper part is made of a slightly thinner silicone material, and a lower part is made of a slightly thicker silicone material.

In one embodiment, a hard gasket 412 is fastened to one side of a side wall of the air guide plate 41, and the hard gasket 412 is located on one side that is of the air guide plate 41 and that is away from the air guide tube 43. Only in this way can pressures inside and outside the feeding bottle be the same, achieving a low negative pressure in the feeding bottle and making milk sucking smoother.

In one embodiment, an air guide through hole 413 is provided at a position at which the side wall of the air guide plate 41 is corresponding to the annular air groove 411 for communication between the air guide tube 43 and the annular air groove 411.

An operation principle is as follows: air enters the annular air groove 411 through the air inlet hole 21 in the nipple 2 and enters the bottom of the bottle body 1 along the air guide tube 43, while milk (drink) in the feeding bottle enters the nipple 2 through the liquid guide channel 421 in the isolation tube 42, which can effectively separate inhaled milk from air, reducing a chance that the infant swallows air. Loss of vitamins in milk can be reduced, the infant does not easily spit up milk due to inhalation of air, and a resistance to milk flowing is reduced, so that the infant can suck milk without effort. When the infant is not sucking milk in the feeding bottle, natural flowing of milk can be reduced as much as possible (that is, a positive pressure generated during bottle feeding is reduced to a minimum), reducing occurrence of vomiting, choking, or flatulence when the infant sucks milk.

In the present invention, unless otherwise specified and limited, the terms such as “install”, “dispose”, “connect”, “fasten”, and “pivotably connect” should be understood broadly. For example, the term “connect” may be a fastened connection, may be a detachable connection, or may be integration; may be a mechanical connection or may be an electrical connection; or may be a direct connection, may be an indirect connection implemented by using an intermediate medium, or may be communication inside two elements or an interaction relationship between two elements. Unless expressly specified otherwise, a person of ordinary skill in the art may interpret specific meanings of the foregoing terms in the present invention according to specific cases.

The foregoing descriptions are merely preferred embodiments of the present invention, but are not intended to limit the present invention. Any modifications, equivalent substitutions, improvements, and the like made within the spirit and principle of the present invention should be included within the protection scope of the present invention.

What is claimed is:

1. A feeding bottle with an air return function, wherein the feeding bottle comprises a bottle body, a nipple, and a bottle cap, the bottle body is provided with an open end and an air guide mechanism, and an outer wall of the open end is provided with threads; the bottle cap is located on the open end and is configured to fasten the bottle body and the nipple, the air guide mechanism comprises an air guide plate, an isolation tube, and an air guide tube, an annular air groove is provided in the middle of one side of the air guide plate, the isolation tube is firmly disposed in the middle of the annular air groove, a liquid guide channel is provided in the middle of the isolation tube for communication between two sides of the air guide plate, the air guide tube is firmly disposed on one side that is of the air guide plate and that is away from the annular air groove, and the inside of the air guide tube communicates with the annular air groove, the nipple is provided with an air inlet hole, and air enters the annular air groove through the air inlet hole.

2. The feeding bottle with an air return function according to claim 1, wherein the bottle body is a transparent bottle body and may be made of any one of glass, a PPSU material, silicone, or plastic.

3. The feeding bottle with an air return function according to claim 1, wherein a milk hole is provided at protrusion in the middle of a mouth of the nipple, the nipple is a dual-hardness silicone nipple, an upper part is made of a slightly thinner silicone material, and a lower part is made of a slightly thicker silicone material.

4. The feeding bottle with an air return function according to claim 1, wherein a hard gasket is fastened to a side of a side wall of the air guide plate, and the hard gasket is located on one side that is of the air guide plate and that is away from the air guide tube.

5. The feeding bottle with an air return function according to claim 1, wherein an air guide through hole is provided at a position at which a side wall of the air guide plate is corresponding to the annular air groove for communication between the air guide tube and the annular air groove.
